(19) United States
(12) Patent Application Publication
(10) Pub. No.: US 2003/0004753 A1
(43) Pub. Date: Jan. 2, 2003

(54) Management method of persons at risk of complications of arterial occlusive disease

(76) Inventors: William M. Blackshear JR., Clearwater, FL (US); Ralph F. Hagemeier, Largo, FL (US); Louise Fischer, Palm Harbor, FL (US)

Correspondence Address: ARTHUR W. FISHER, III, Suite 316, 5553 West Waters Avenue, Tampa, FL, 33634, US

(21) Appl. No.: 09/894,174

(22) Filed: Jun. 27, 2001

(51) Int. Cl. G06F 17/60

(52) U.S. Cl. 705/2

(57) ABSTRACT

A method for the management of persons at risk of complications of arterial occlusive disease comprising evaluating a population of persons to identify those persons potentially at risk of complications of arterial occlusive disease, examining those persons evaluated potentially at risk of complications of arterial occlusive disease, classifying those persons determined to be at risk of complications of arterial occlusive disease, treating those persons classified at risk of complications of arterial occlusive disease and monitoring those persons treated for arterial occlusive disease to determine prognosis and efficacy of treatment.

### BACKGROUND OF THE INVENTION

1. Field of the Invention

A method for the management of persons at risk of complications of arterial occlusive disease.

2. Description of the Prior Art

As the average age of the population increases, the number of nursing homes and residents has grown rapidly. With this growth is a dramatic increase in the medical care needs of this population.

Unfortunately, arterial occlusive disease (ASO) is a common condition in the elderly skilled nursing facility (SNF) resident population. When severe, this disease can produce critical ischemia, which may lead to skin breakdown and ulceration, often culminating in limb loss. Unfortunately, severe ASO often goes unrecognized as its signs and symptoms are often not detected by primary care physicians and/or SNF nursing personnel. Appropriate treatment is thus frequently delayed and, when rendered, may be insufficient or inappropriate to resolve the resident's acute problem. As extended periods of fatal wound care and progressive debility culminating in loss of limb and or life is the unfortunate outcome in far too many cases.

There have been a number of efforts to enhance the diagnosis and treatment of various illnesses through the use of computer based systems and protocols including the following examples.

U.S. Pat. No. 5,584,297 teaches a method and apparatus to diagnose a circulation disorder and predict whether a patient is likely to suffer a stroke. The diagnosis is based on a patient's responses to questions regarding whether the patient has experienced symptoms of a neurological disorder on electrical brain activity and blood pulse activity. The diagnosis may be based upon a comparison of the patient's electrical brain activity on the right and left sides of the patient's brain and on a comparison of the pulse activity on the right and left sides of the patient's head, arms and legs. The diagnosis may further be based on the results of a stress test that measures the patient's blood pressure, pulse rate and anxiety level. Further, the diagnosis may include whether the patient exhibits one or more arteriosclerosis risk factors such as age, weight, height, sex, blood cholesterol level and blood sugar level.

U.S. Pat. No. 5,993,386 describes a computerized technique for performing a medical outcomes analysis including methods for quantifying a patient's state of health to enhance the quality of care and improve diagnostic techniques.

U.S. Pat. No. 6,154,726 discloses a system and method for processing patient data to record, accurately and precisely, historical patient care information. Data elements used in the determination of the generated clinical status code include a level of history of the patient, a level of examination of the patient, a decision-making process of the physician treating the patient, and a “time influence factor.” The quantity and quality of care information for a particular patient improves future care decisions for that patient based on a more complete medical history and track the efficacy of specific treatment protocols.

However, there remains a specific need to identify, treat and document the management of persons suffering from arterial occlusive disease.

### SUMMARY OF THE INVENTION

The present invention relates to a method for the management of persons at risk of complications of arterial occlusive disease comprising a process to identify and treat persons in healthcare facilities such as a skilled nursing facility. Of course, the management method is equally useful and effective with a person whether confined to a healthcare facility or on an out patient basis. In general, the management method comprises evaluating a population of persons to identify persons potentially at risk of complications of arterial occlusive disease, examining those persons identified as potentially at risk of complications of arterial occlusive disease to determine those persons at risk of complications of arterial occlusive disease, classifying those persons determined to be at risk of complications of arterial occlusive disease, treating those persons classified at risk of complications of arterial occlusive disease and monitoring those persons treated for arterial occlusive disease to determine prognosis and efficacy of treatment.

The management system is designed to improve the care of residents with lower extremity arterial occlusive disease by instituting a multi-step program in the skilled nursing facility to identify patients at risk for complications related to lower extremity arterial occlusive disease, refer such patients for appropriate diagnostic and therapeutic care and to document the significant aspects of the specific management. To assure quality of care, an ongoing training and compliance program is maintained within each facility to enhance the awareness of arterial occlusive disease management among the healthcare personnel and confirm continued compliance with all aspects of the management system.

In addition to the clear benefits and improvement in quality of life afforded to residents with these problems, the management system is designed to minimize complications of arterial occlusive disease including limb loss.

The management system employs specific criteria developed to identify persons at risk for critical arterial occlusive disease. These criteria are based on admitting diagnoses and/or diagnoses after admission by the nursing and physician history and physical examinations. It is anticipated that these criteria will identify the great majority of residents who may potentially suffer from critical ischemia, symptomatic or not. Any resident with an extremity ulcer can also be evaluated for critical arterial occlusive disease.

Specific sections of a minimum data set and complete admission history as well as physical examination are reviewed by medical staff following admission. Out patient examination as well as preadmission screening can be employed if requested by the facility. In addition, admission total body assessment data will be included in this initial review. The skilled nursing facility personnel are trained to focus on specific findings designed to increase the accuracy of detection of arterial occlusive disease and classification of limb ulceration.

The foregoing data will be transmitted and preliminary classification of “potentially at risk” or “not at risk” for developing complications of arterial occlusive disease by a management medical staff. Residents who are not found to be at risk but who have extremity ulcers on admission or who develop in-house acquired extremity ulcers will be evaluated on a regular monthly basis by the management system nursing staff until the lesion(s) are healed. Failure to make sufficient progress toward healing on each monthly evaluation requires a referral for noninvasive and/or vascular surgical evaluation and attendant reclassification if dictated.

Identification or classification of a patient “potentially at risk” for complications of arterial occlusive disease will prompt referral to a noninvasive vascular laboratory accredited in lower extremity vascular diagnosis by the Intersocietal Commission for the Accrediation of Vascular Laboratories (ICAVL). This national organization certifies vascular laboratories to assure that examinations are appropriately and accurately conducted. The examination is to be completed promptly following the preliminary classification as “potentially at risk” and the results of the examination are transmitted to the management medical staff. This data forms the basis upon which the final classification of “at risk” or “not at risk” will be based.

Persons so classified “at risk” for critical ischemia with associated extremity lesions and those with noninvasive evidence of severe ischemia are referred for a vascular surgical evaluation days following final classification as “at risk”. The purpose of this examination will be to determine whether immediate revascularization is dictated.

Each vascular surgery evaluation will be reviewed by the management medical staff upon transmission by the facility and used as a basis for periodic evaluation. Any patient failing to make sufficient progress in healing an extremity ulcer may be referred for followup vascular laboratory and or vascular surgery evaluations upon the recommendation of the management system staff after their regular monthly assessments. In addition, any person with signs or symptoms suggestive of deteriorating arterial blood flow may also be referred for vascular laboratory evaluation.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a schematic flow chart of the method of the present invention.

FIG. 2 is a schematic network sharing the various healthcare providers interconnected by communications to implement the method of the present invention.

FIG. 3 is a typical data storage and communications station configured for use by the various healthcare providers to implement the method of the present invention.

Similar reference characters refer to similar parts throughout the several views of the drawings.

### DETAILED DESCRIPTION OF THE PREFERRED EMBODIMENT

The present invention relates to a method for the management of persons at risk of complications of arterial occlusive disease comprising a process to identify and treat persons in healthcare facilities. In general, the management method comprises evaluating a population of persons to identify persons “potentially at risk” of arterial occlusive disease, examining those persons identified as “potentially at risk” of arterial occlusive disease to determine those persons “at risk” of arterial occlusive disease, classifying those persons determined to be “at risk” of arterial occlusive disease, treating those persons classified “at risk” of arterial occlusive disease and monitoring those persons treated for arterial occlusive disease to determine prognosis and efficacy of treatment.

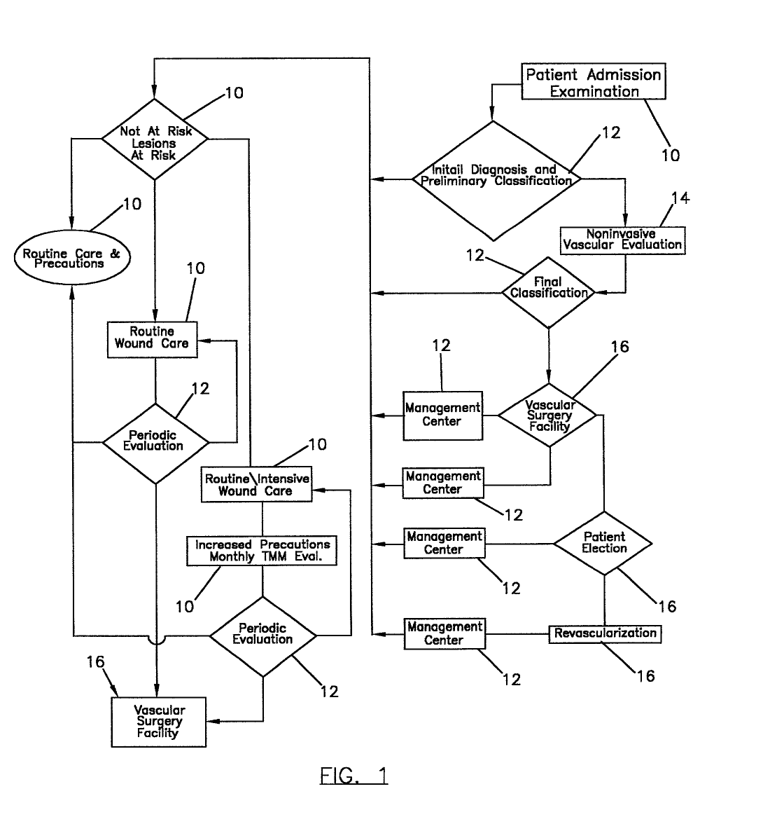

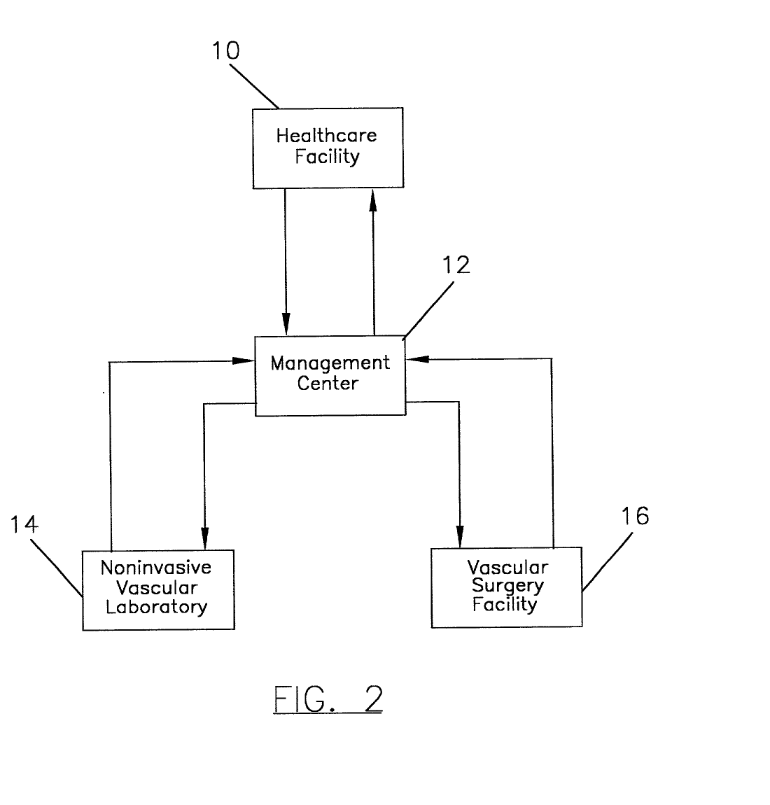

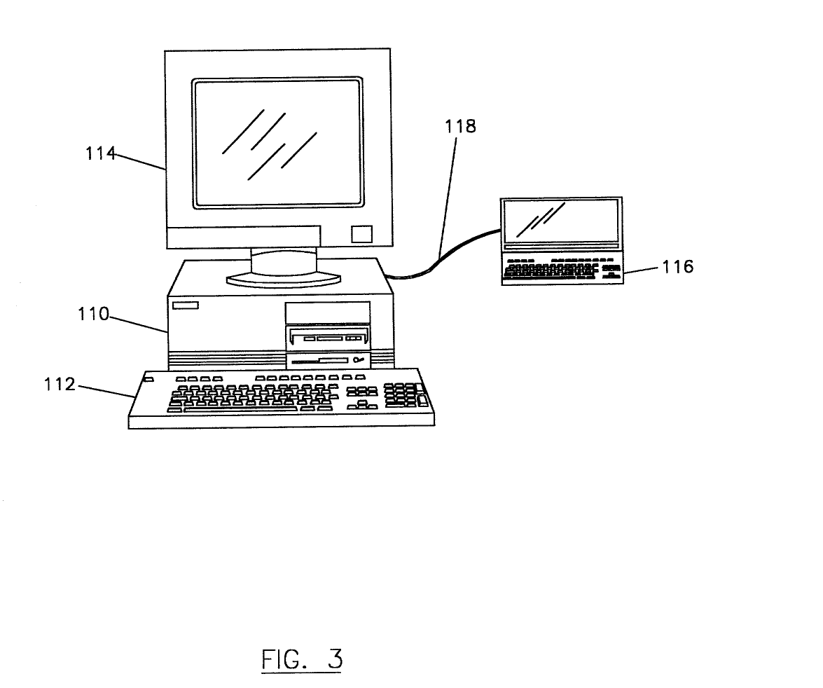

The management method is best understood by reference to FIGS. 1 and 2. As shown, data and information is transmitted over any appropriate state of the art communications network or transmission links between a healthcare facility 10 primarily responsible for the care of a population of persons who may include persons “at risk” of arterial occlusive disease, a management center 12 responsible for the management and administration of the method of the instant invention including the preliminary and final classification, a noninvasive vascular laboratory or facility 14 capable of performing noninvasive vascular evaluations to derive data upon which to determine final classification of “not at risk” or “at risk” and a vascular surgery facility 16 capable of assessing persons “at risk” of arterial occlusive disease for vascular surgery or alternative treatment. This data and information is recorded and stored at the various sites on a local system such as shown in FIG. 3.

The local systems are linked together as shown in FIG. 2 to transmit data and information between the various sites. Specifically, each local system may comprise a desktop computer including a CPU 110 coupled to a keyboard 112 and a CRT display 114. A hand-held personal computer 116 may be linked to the desktop computer by a cable 118. The personal computer 116 can be detached from the desktop computer and taken with the medical personnel to enter and extract information. The hand-held personal computer 116 reconnects to the desktop computer by means of the cable 118 to transfer information therebetween.

More specifically, a specific set of criteria to identify persons at risk of complications of arterial occlusive disease have been identified. Such criteria include patient diagnoses, pertinent physical findings and objective non invasive arterial pressure and flow data observed, collected and recorded during patient examination, admission or preadmission, at the healthcare facility 10, doctor's office or clinic, where persons provide a medical history and are physically examined. This data is transmitted to a management medical staff at the management center 12 who are specifically trained to identify persons “potentially at risk” of arterial occlusive disease for initial diagnosis and preliminary classification as “potentially at risk” or “not at risk” of arterial occlusive disease. In particular, the evaluating authority or management medical staff compares the individual patient data sets against the predetermined set of disease specific criteria to provide an initial diagnosis and preliminary classification of those persons “potentially at risk” and those persons “not at risk” of developing complications of arterial occlusive disease. This preliminary classification data is transmitted to the healthcare facility 10.

Those persons classified as “potentially at risk” of arterial occlusive disease are referred to an Intersocietal Commission for the Accrediation of Vascular Laboratories (ICAVL) accredited or equivalent laboratory 14 for a noninvasive vascular evaluation. The results of the individual noninvasive vascular evaluations are recorded and then transmitted to the reviewing medical staff at the management center 12 for final classification of the person or patient as “at risk” or “not at risk”. This final classification is transmitted to the healthcare facility 10 and recorded.

Those persons or patients having a final classification of “at risk” for critical ischemia with associated extremity lesions and those with noninvasive evidence of severe ischemia are referred to vascular surgery facility 16 for vascular surgical assessment to determine whether immediate revascularization is necessary. Of course, this assessment may be based upon the person's medical history having undergone a recent vascular surgery evaluation. The persons or patients are assessed as “clinical indication for operation” or “no indication for operation”. This assessment is at the vascular surgery facility 16 is transmitted to the medical staff at management center 12 for review. Persons or patients assessed as “clinical indication for operation” are informed of the assessment. The person or patient may elect or choose either revascularization and periodic management system evaluation at the healthcare facility 10 or routine wound care and periodic revaluation at the healthcare facility 10.

Persons or patients assessed as “no indication for operation” are monitored by the healthcare facility 10 with increased precautions to monitored for detection of any deterioration that would require detectible reassessment. If the person or patient has ulcers, pain or gangrene, the person or patient is referred for reassessment at the time of “no indication for operation” assessment, the reasons for not referring the person as “critical indication for operation” are recorded. Further, when a “no indication for operation” person or patient develops ulcers, pair and/or gangrene, the person or patient is referred to the vascular surgery facility 16 for reassessment. The assessment results of “no indication for operation” and “clinical indication for operation” are transmitted to the management center 12 for reevaluation and then to the healthcare faculty 10 for the appropriate medical procedure and regimen.

The healthcare facility 10 treats and monitors those persons or patients classified as “not at risk”, “at risk” and assessed as “no indication for operation” or “clinical indication for operation” at the healthcare facility 10. “Not at risk” persons or patients without limb ulcers receive routine care and precautions. “Not at risk” persons or patients with ulcers receive routine wound care at the healthcare facility 10 and periodic reevaluations by the management center 12, “at risk” persons or patients assessed as “no indication for operation” or “operation not elected by patient” and “clinical indication for operation” undergoing or not undergoing revascularization at the vascular surgery facility 16 receive intensive wound care and periodic reevaluations with increased precautions at the healthcare facility 10.

In this manner, the method for management of persons at risk and potentially at risk of complications of arterial occlusive disease are evaluated, classified, assessed, treated, monitored, reevaluated and reassessed under a strict protocol calculated to minimize the risk and suffering of arterial occlusive disease.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A method for the management of persons at risk of complications of arterial occlusive disease comprising evaluating a population of persons to identify those persons potentially at risk of complications of arterial occlusive disease, examining those persons evaluated potentially at risk of complications of arterial occlusive disease, classifying those persons determined to be at risk of complications of arterial occlusive disease, treating those persons classified at risk of complications of arterial occlusive disease and monitoring those persons treated for arterial occlusive disease to determine prognosis and efficacy of treatment.

2. The management method of claim 1 wherein those persons classified as potentially at risk of complications of arterial occlusive disease are referred for noninvasive vascular evaluation.

3. The management method of claim 2 wherein patient data sets are compared against the predetermined set of disease specific criteria to provide a preliminary classification of those persons potentially at risk and those persons not at risk of developing complications of arterial occlusive disease.

4. The management method of claim 2 wherein the results of the individual noninvasive vascular evaluations are reviewed for final classification of the person or patient as at risk or not at risk.

5. The management method of claim 4 further comprising assessing by vascular surgical to determine if revascularization is necessary and to identify those persons or patients as clinical indication for operation or indication for no operation.

6. The management method of claim 5 wherein persons or patients assessed as no indication for operation are monitored with increased precautions for detection of any deterioration dictating reassessment.

7. The management method of claim 6 wherein when a no indication for operation person or patient develops ulcers, pair and/or gangrene, the person or patient is referred to the vascular surgery facility for reassessment for a no indication for operation and clinical indication for operation for reevaluation and appropriate medical procedure and regimen.

8. The management method of claim 5 wherein the persons or patients assessed as clinical indication for operation are informed of the assessment, the person or patient electing either revascularization and periodic evaluation or routine wound care and periodic revaluation.

9. The management method of claim 8 wherein the persons or patients are monitored with increased precaution for detection of deterioration dictating reassessment.

10. The management method of claim 9 wherein the persons or patients are reassessed for revascularization when medically dictated.

11. The management method of claim 2 wherein routine care and precautions is administered to not at risk persons or patients without limb ulcers.

12. The management method of claim 11 wherein not at risk persons or patients with ulcers receive routine wound care and periodic reevaluations.

13. The management method of claim 8 wherein at risk persons or patients assessed as no indication for operation or operation not elected by patient and clinical indication for operation undergoing or not undergoing revascularization at the vascular surgery facility receive routine wound care and periodic reevaluations with increased precautions at the healthcare facility.

14. A method for the management of persons at risk of complications of arterial occlusive disease including evaluating a population of persons to identify those persons potentially at risk of complications of arterial occlusive disease, examining those persons evaluated potentially at risk of complications of arterial occlusive disease, classifying those persons determined to be at risk of complications of arterial occlusive disease, treating those persons classified at risk of complications of arterial occlusive disease and monitoring those persons treated for arterial occlusive disease to determine prognosis and efficacy of treatment, said management method comprising a healthcare facility primarily responsible for the care of a population of persons who may include persons at risk of complications of arterial occlusive disease, a management center responsible for management and administration of said method including the preliminary and final classification, a noninvasive vascular facility performing noninvasive vascular evaluations the management center derive data upon which to determines final classification of not at risk or at risk and a vascular surgery facility assessing persons at risk of complications of arterial occlusive disease for vascular surgery or alternative treatment.
